(19) United States
(12) Patent Application Publication
(10) Pub. No.: US 2009/0321425 A1
(43) Pub. Date: Dec. 31, 2009

(54) METHOD FOR CONTROLLING AN INDUCTION COOKING APPLIANCE AND INDUCTION COOKING APPLIANCE

(76) Inventor: Werner Meier, Feldmeilen (CH)

Correspondence Address: OSTROLENK FABER GERB & SOFFEN, 1180 AVENUE OF THE AMERICAS, NEW YORK, NY, 100368403, US

(21) Appl. No.: 12/514,150

(22) PCT Filed: Nov. 1, 2007
(86) PCT No.: PCT/CH2007/000541

§ 371 Date: Jul. 14, 2009

(30) Foreign Application Priority Data
Nov. 9, 2006 (CH) 1778/06

(51) Int. Cl. H05B 6/06

(52) U.S. Cl. 219/621; 219/663

(57) ABSTRACT

The invention relates to a method for controlling an induction cooking appliance with at least one coil, wherein the power of the coil is adjusted as a function of a position of a cooking utensil on the coil. The invention also relates to an induction cooking appliance for heating a cooking utensil, which has at least one coil and a drive unit for the coil, the induction cooking appliance being designed to implement the mentioned method.

### REFERENCE TO RELATED APPLICATIONS

This application claims the priority of Swiss patent application no. 01778/06 which was filed on Nov. 9, 2006 and of which the entire disclosure is hereby incorporated by reference.

### TECHNICAL FIELD

The invention relates to a method for controlling an induction cooking appliance according to the preamble of claim 1, and to an induction cooking appliance for heating a cooking vessel according to the preamble of claim 10. An induction cooking appliance is to be understood, for example, as an induction cooker. A cooking vessel may be, for example, a pan.

### PRIOR ART

Patent application EP A1-0 706 304 discloses a cooking appliance with an inductive heating apparatus, which cooking appliance is located beneath a rectangular cooking plate. The heating apparatus has four heating elements which are designed in such a way that the edge regions of the cooking plate can also be used for cooking purposes. Each heating element comprises a flat inductor with substantially helical turns, with the respective turns having portions which run virtually in a straight line and are connected in series, and the respective turn portion, which runs in a straight line, runs parallel to one of the sides of the cooking plate.

In induction cookers or the cooking plates of induction cookers, the power required for cooking purposes is usually controlled by means of additional operator control elements, such as potentiometers, rotary switches, jog keys or similar operator control elements.

However, as soon as a plurality of pans or pots are to be heated on an induction cooker, operation of such additional operator control elements becomes complicated and there is a risk of confusion between the operator control elements, in particular when the operator control elements are not arranged directly next to the corresponding hob, as is often the case. Furthermore, the additional operator control elements require additional space and entail costs. If the additional operator control elements are designed as jog keys which are arranged directly beneath the cooking surface which is typically formed from glass ceramic, operator control is often complicated and, when the cooking surface is dirty, is often possible only after said cooking surface has been cleaned. Furthermore, the jog keys to be touched may have been heated by a hot cooking vessel which was previously on this area of the cooking surface, and so making contact with said keys may be uncomfortable or even painful.

### SUMMARY OF THE INVENTION

The object of the present invention is to provide a method for controlling an induction cooking appliance, which method permits simple operation of an induction cooking appliance, and an induction cooking appliance which is easy to operate.

This object is achieved by a method for controlling an induction cooking appliance having the features of claim 1, and by an induction cooking appliance for heating a cooking vessel having the features of claim 10.

In the method according to the invention for controlling an induction cooking appliance which has at least one coil, the power of the coil, which is also called the heating power, is adjusted as a function of a position of a cooking vessel on the coil. The induction cooking appliance according to the invention for heating a cooking vessel, which induction cooking appliance has at least one coil and a drive unit for this coil, is distinguished in that the induction cooking appliance, in particular the drive unit of said induction cooking appliance, is designed to execute the method according to the invention. The coil is understood to be, in particular, an inductor.

Since the heating power of the coil can be adjusted as a function of the position of the cooking vessel on the coil, additional operator control elements, such as the potentiometers, rotary switches, jog keys or similar operator control elements mentioned above by way of example, are advantageously not required and the space required for these and the costs incurred as a result can be saved. Furthermore, no confusion can occur between the cooking vessels to be heated, this confusion possibly being caused by an additional operator control element being operated, but this operator control element being associated with a different hob to that on which the cooking vessel to be heated is located.

The heating power of the induction cooking appliance or one its coils can therefore advantageously be controlled solely by the position of a cooking vessel on a coil of the induction cooking appliance being changed. It goes without saying that additional operator control elements, such as those mentioned above, for example in the form of rotary switches or jog keys, can be provided for additional control of the heating power.

In the method according to the invention, an actual value, which is dependent on the position of the cooking vessel on the coil, is preferably determined. This actual value is then compared with a predefined setpoint value so as to form a difference, and, when the actual value differs from the setpoint value, that is to say when a difference is greater than zero, the power of the coil is adjusted in such a way that the actual value is adjusted to the setpoint value. The setpoint value is preferably predefined as a value of a setpoint curve, with the values of the setpoint curve being dependent on the pulse duration and/or the period duration of an induction current for the coil.

It goes without saying that, when the actual value differs from the setpoint value, the power of the coil can also be adjusted by means of a controller, for example a P controller (proportional controller), a PI controller (proportional plus integral controller) or a PID controller (proportional plus integral plus derivative controller), with the determined difference forming an input variable for the controller.

### BRIEF DESCRIPTION OF THE DRAWINGS

Further advantageous refinements of the invention can be gathered from the dependent claims and the exemplary embodiments which are explained below with reference to the drawings, in which:

FIG. 1 shows a plan view of an exemplary hob of an induction cooking appliance having three hobs;

FIG. 2 shows a schematic illustration of an induction cooking appliance with a cooking vessel arranged on it;

FIG. 3 shows a graph which illustrates the power consumed by a coil of the induction cooking appliance as a function of the pulse duration of the drive current of the coil;

FIG. 4 shows a schematic illustration of a cooking vessel on a hob of an induction cooking appliance, with the cooking vessel being centered over the coil of the hob in FIG. 4a) and being arranged on the hob with the edge of the cooking vessel intersecting the center of the hob in FIG. 4b);

FIG. 5 shows a graph which illustrates the ratio of the induction current to the mains current as a function of the pulse duration; and

FIG. 6 shows a further graph which illustrates the ratio of the induction current to the mains current as a function of the pulse duration.

In the figures, identical reference symbols denote components or elements which are structurally or functionally identical or act in a structurally or functionally identical manner.

Ways of Implementing the Invention

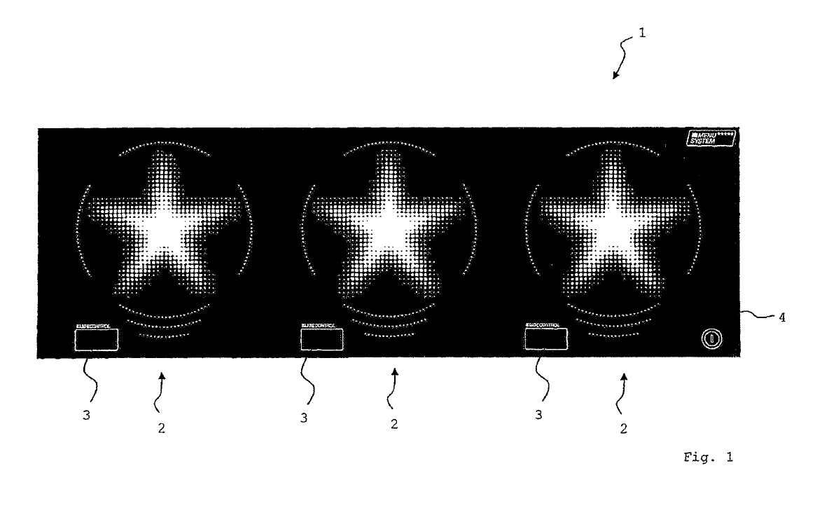

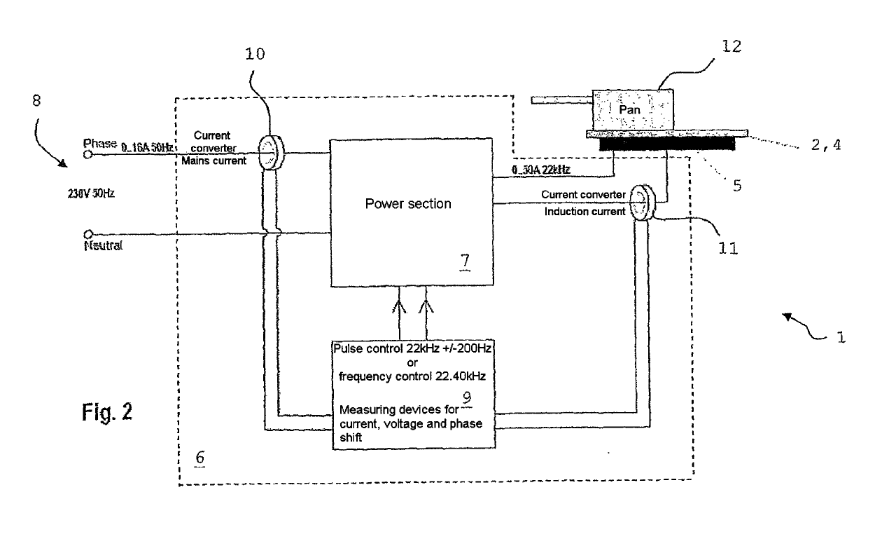

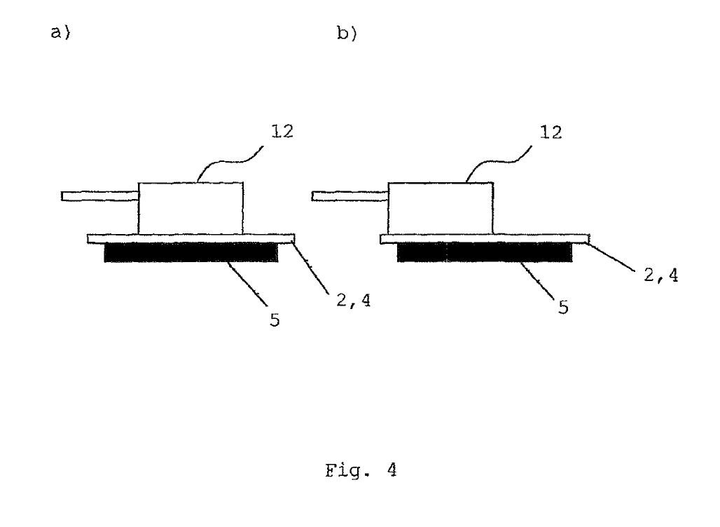

FIG. 1 shows a plan view of an induction cooking appliance 1 with, by way of example, three hobs 2, with each hob 2 having, for heating purposes, a coil 5 beneath the cooking surface 4 (cf. FIGS. 2 and 4). The hobs 2 are preferably arranged in a row and aligned with one another. The cooking surface 4 is typically composed of a heat-resistant and at least partially transparent material, in particular glass ceramic. In order to heat food, this food is accommodated in a metal cooking vessel 12 on one of the hobs 2 (cf. FIGS. 2 and 4) and heated by eddy currents which are produced in the metal cooking vessel 12 and are induced in the cooking vessel when an induction current flows through the coil 5 which is associated with the respective hob 2.

Each hob 2 preferably has, on the cooking surface 4, a display unit 3 on which the momentary power of the coil 5 which is associated with the hob 2 is displayed. It goes without saying that a number of hobs 2 which differs from the number of hobs 2 illustrated in FIG. 1 may also be provided, it being possible for the hobs 2 to not be provided in a row but also in other arrangements. Beneath the cooking surface 4, the induction cooking appliance 1 may be designed, for example, as a carriage or as a cabinet and comprises a drive unit 6 for the coils 5 of the hobs 2.

FIG. 2 shows a schematic illustration of the induction cooking appliance 1 with a hob 2 on which a cooking vessel 12 in the form of a pan is situated. A coil 5 in the form of a flat inductor is arranged beneath the hob 2 in order to heat the cooking vessel 12. The induction cooking appliance 1 has a drive unit 6 for driving the coil 5 which is connected to the coil 5 via cables (not provided with a designation). The drive unit 6 has a power section 7 which is connected to a current source 8 and to the coil 5 via cables (not provided with a designation).

The coil 5 is designed, in particular, as a disk-type coil, that is to say the turns of the winding of the coil 5 lie in one plane and form a spiral. The winding is preferably designed as a radio-frequency wire, with the turns of the winding being mounted on a side of a base plate (not illustrated) which faces the hob 2. The windings may, for example, be fixed on the base plate with the aid of adhesive. The ends of this winding form connection conductors to which the power section 7 is connected.

The current source 8 is preferably a current supply system or power supply system which is usually found in a building and which has, for example in Switzerland, a mains voltage of 230 volts and a frequency of 50 hertz, with the mains current typically being between 0 and 16 amperes and having a frequency of 50 hertz.

The power section 7 generates an induction current for the coil 5 (also called the drive current) from the mains current, with the power section 7 being driven by a control unit 9 for this purpose. The power section 7 is, in particular, a pulse generator or a frequency generator. If a pulse generator is used as the power section 7, the pulse length or pulse duration of the pulse of the induction current, and in this way the heating power of the coil 5, is/are controlled by means of the control section 9. The induction current is preferably between 0 and 50 amperes. The power output by the coil 5 may be between 50 watts and 20 kilowatts.

If the power section 7 is designed as a pulse generator and therefore the pulse of the induction current is controlled, the induction current preferably comprises a current component with a fixed fundamental or operating frequency, for example 22 kilohertz, and a symmetrical pulse current, of which the pulse duration or pulse length can be controlled by the control unit 9 via the power section 7. A pulse control method of this type is described, for example, in CH 696649 A5. When the power is controlled by means of the pulse length or pulse duration of the induction current, the frequency of the induction current is preferably 22 kilohertz±200 hertz, with 22 kilohertz representing the fundamental or operating frequency.

If the power section is designed as a frequency generator and therefore the frequency of the induction current is controlled, the frequency of the induction current is preferably in the inaudible range of between 22 and 40 kilohertz.

A sensor 10, which is preferably designed as a current converter, for measuring the mains current is provided, said sensor being connected to the control section 9 so that the measured values from the sensor 10 can be transmitted to the control unit 9. Also provided is a sensor 11 for measuring the induction current, this sensor likewise being connected to the control unit 9 so that its measured values can be transmitted to the control unit 9.

The induction current is load-dependent. Consequently, it is dependent on the position of a load in the form of a metal cooking vessel 12 on the coil 5. Since the induction current and therefore the power of the coil 5 are load-dependent, the power output by the coil 5 can be changed by means of the position of a cooking vessel 12 on the coil 5.

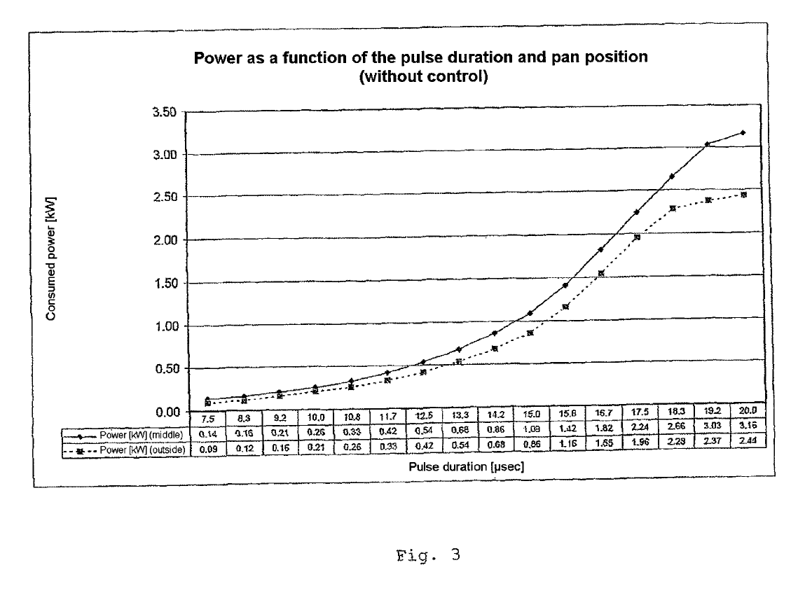

FIG. 3 shows the power of the coil 5 in kilowatts as a function of the pulse duration of the induction current in microseconds. The solid-line curve shows the profile of the power when the cooking vessel 12 is centered, that is to say is aligned exactly with the center of the coil 5, on the hob 2. This position of the cooking vessel 12 is schematically illustrated in FIG. 4a). The dashed-line curve in FIG. 3 shows the profile of the power when the cooking vessel 12 is not oriented such that it is centered on the coil 5 but when the edge of the cooking vessel 12, for example a pan edge, intersects the center of the hob 2 and therefore the center of the coil 5. This is schematically illustrated in FIG. 4b).

FIGS. 3, 5 and 6 show exemplary curve profiles for a cooking vessel 12 in the form of a specific pan which is placed on a coil 5 in the form of a flat inductor which is dimensioned to match a specific type. Furthermore, the illustrated curve profiles can be dependent on further components which determine power. Equally, the numerical values cited further in the text are of purely exemplary nature.

FIG. 3 shows an exemplary graph which shows that the power of the coil 5 increases as the pulse duration increases. The power is higher when the cooking vessel 12 is arranged centered on the coil 5 than when the cooking vessel 12 is moved from the center of the coil 5, particularly at high pulse durations. The power of the coil 5 can therefore be reduced by moving the cooking vessel 12 away from the hob 2 and therefore from the coil 5. Therefore, for example at a pulse duration of 20 microseconds, the power can be reduced from 3.16 kilowatts to 2.44 kilowatts by moving the cooking vessel 12 into the position illustrated in FIG. 4b). In the medium power range, the power can be reduced from 1.09 kilowatts to 0.86 kilowatt at a pulse duration of 15 microseconds by moving from the position according to FIG. 4a) to the position according to FIG. 4b).

If the cooking vessel 12 is moved away from the center of the hob 2 or the coil 5 to such an extent that the center of the coil 5 is no longer covered by the cooking vessel 12, that is to say not even by the edge of said cooking vessel, this leads to entirely different heating of the food located in the cooking vessel 12, and this is to be avoided. The cooking vessel 12 is therefore preferably moved at most to such an extent that its edge intersects the center of the coil 5 (see FIG. 4b)).

In order to achieve a greater power reduction than that mentioned above when moving the cooking vessel 12 on the coil 5, an actual value, which is dependent on the position of the cooking vessel 12 on the coil 5, is preferably determined and compared with a predefined setpoint value. The actual value is preferably the ratio of the induction current, which is also called the RF current (radio-frequency current), to the mains current. In this case, the induction current is measured by means of the sensor 11 and the mains current is measured by means of the sensor 10. The determined actual value is then compared with the corresponding value of a setpoint curve which is stored in the control unit 9 and of which the values are dependent on the pulse duration of the induction current. That is to say, the actual value which is determined at a specific pulse duration is compared with the setpoint value, which corresponds to this pulse duration, of a stored setpoint curve.

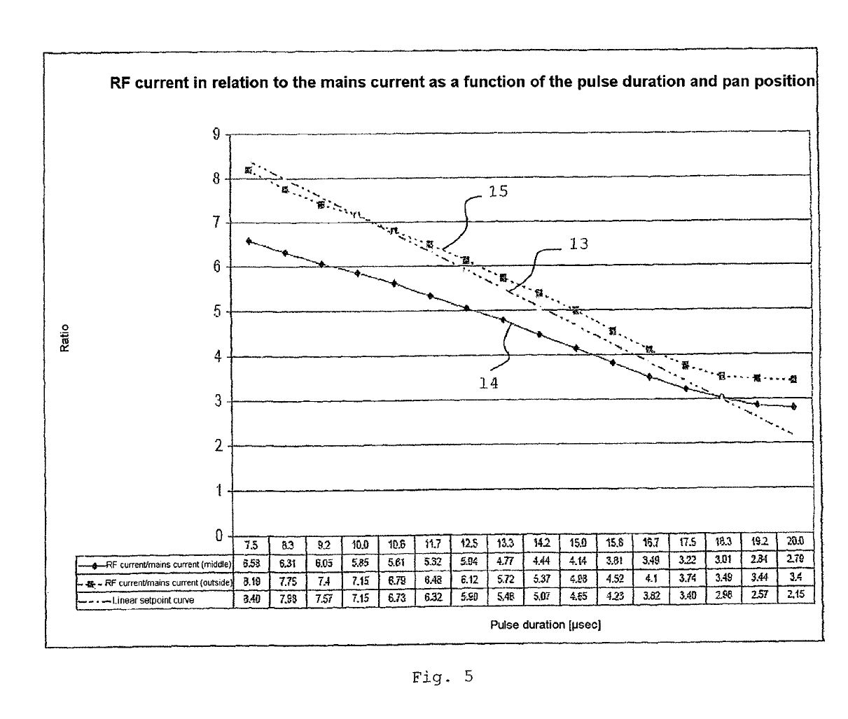

FIG. 5 shows, by way of example, the actual value formed as a ratio of the induction current to the mains current as a function of the pulse duration, and a linear setpoint curve 13 which is formed as a straight line with a negative gradient. The setpoint curve 13 has a negative gradient particularly when the ratio of the induction current to the mains current is used as the actual value. The solid-line curve 14 shows the ratio between the induction current and the mains current, which can also be called the active current, as a function of the pulse duration for the case in which the cooking vessel 12 is positioned such that it is centered on the coil 5 (cf. FIG. 4a)). The dashed-line curve 15 shows the ratio of the induction current to the mains current when the cooking vessel 12 is not centered on the coil 5 but is arranged in such a way that the edge of the cooking vessel 12 intersects the center of the hob 2 and therefore of the coil 5 (cf. FIG. 4b)). The setpoint curve 13, which is illustrated with a dash-dotted line, intersects the curves 14 and 15 preferably at two points (not provided with a designation) and otherwise runs between them.

At a given pulse duration, the induction current is measured by means of the sensor 11 and the mains current is measured by means of the sensor 10 and the ratio of the induction current to the mains current is determined as the actual value, as already cited. This actual value is then compared with the corresponding value of the setpoint curve 13, and the difference between the actual value and the setpoint value is determined. If the actual value is greater than the setpoint value, the pulse duration of the induction current is reduced until the actual value is adjusted to the setpoint value. The reduction in the pulse duration results in a reduction in the power of the coil 5. If the actual value is lower than the setpoint value, the pulse duration is increased until the actual value is adjusted to the setpoint value. Increasing the pulse duration results in an increase in the power of the coil 5.

A controller, for example a P controller, a PI controller or a PID controller, can be used to adjust the actual value to the setpoint value. The use of a corresponding controller can provide improved dynamic adjustment characteristics, that is to say a better transient response, and more accurate adjustment. In particular, an exponential adjustment response can be achieved. If the controller has an integral component, a stationary control error of zero can advantageously be achieved.

The points at which the setpoint curve 13 intersects the curves 14 and 15 define the power adjustment range of the coil 5. Therefore, the point at which the setpoint curve intersects the curve 14 defines the power for the case in which the cooking vessel 12 is exactly in the center of the hob 2. The point at which the setpoint curve 13 intersects the curve 15 defines the case in which the edge of the cooking vessel 12 intersects the center of the hob 2. As cited above, the cooking vessel 12 is preferably moved only between these two positions, that is to say it is not moved further away from the center than as illustrated in FIG. 4b).

If the cooking vessel 12 is in the center of the hob 2, this produces a pulse duration of 18.3 microseconds, which results in a power of the coil 5 of 2.66 kilowatts (cf. FIG. 3, the solid-line curve). If the edge of the cooking vessel 12 intersects the center of the hob 2, this produces a pulse duration of approximately 10 microseconds, which results in a power of 0.21 kilowatt (cf. FIG. 3, the dashed-line curve). The power range of from 0.21 kilowatt to 2.66 kilowatts is a power range which is highly suitable for cooking.

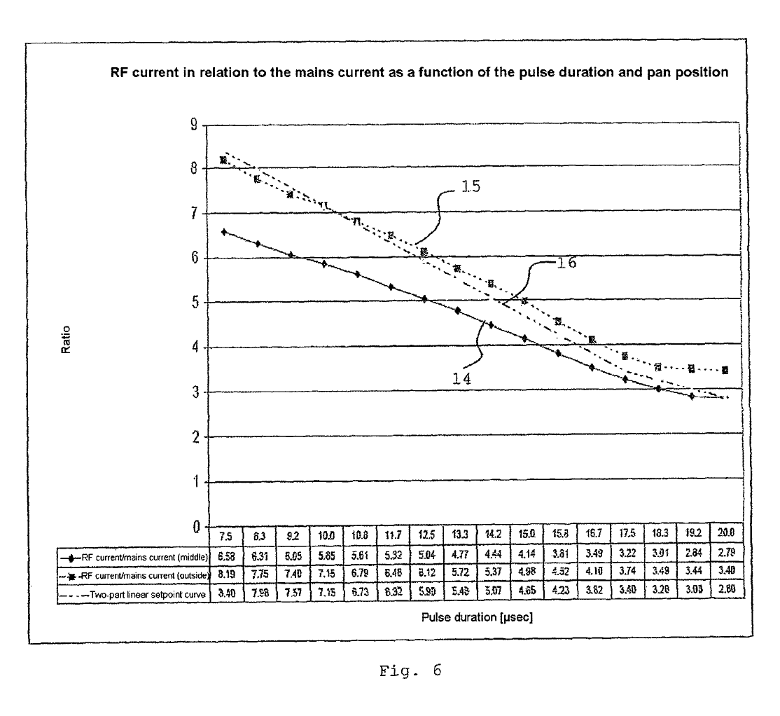

Nevertheless, it may be desirable to use a higher power, for example a power of 3.16 kilowatt (cf. FIG. 3: the value of the solid-line curve at a pulse duration of 20 microseconds). This can be achieved by the setpoint curve being formed in such a way that the magnitude of its gradient decreases as the pulse duration of the induction current increases. The reduction in the magnitude of the gradient can be realized by, as illustrated in FIG. 6, a setpoint curve 16 which comprises two linear sections being used, with the section up to a pulse duration of 17.5 microseconds corresponding to the setpoint curve 13 illustrated in FIG. 5, and the section for pulse durations of greater than or equal to 17.5 microseconds having a lower gradient magnitude than the setpoint curve 13. The setpoint curve 16 correspondingly first intersects the curve 14 at a pulse duration of 20 microseconds instead of at a pulse duration of 18.3 microseconds, like the setpoint curve 13. The setpoint curve 16 is therefore situated between the curves 14 and 15 for a larger pulse duration range. This advantageously results in a larger power range. The power of 3.16 kilowatts is then produced at a pulse duration of 20 microseconds (cf. FIG. 3, the solid-line curve).

It goes without saying that the setpoint curve 16 may also have a different design, for example in the form of a quadratic function, an exponential function, a hyperbola, a parabola or the like. It may also be made up of a plurality of sections.

In addition, other pulse duration- or position-dependent signals can be used instead of the ratio of the induction current to the mains current. For example, the phase shift or a time delay of the induction current can be used as the actual value, with, in particular, the phase shift or time delay between the first current zero crossing of the induction current and a drive pulse being meant. A drive pulse is understood to be a pulse which is generated by the power section 7 and is not subjected to the load—that is to say to the cooking vessel 12—, that is to say which is not subjected to phase shifting as a function of load. With this choice of actual value, the control unit 9 may be, instead of a microcontroller, an operational amplifier for example, since substantially no complex mathematical analyses have to be carried out for power control.

Furthermore, the mains current, the ratio of the mains voltage to the active current and/or the power can be used as the actual value. In these cases, the control unit 9 comprises, as in the case of the actual value corresponding to the ratio of the induction current to the mains current, a microcontroller of this kind. If the ratio of the mains voltage to the active current is used as the actual value, this has the advantage that voltage fluctuations in the power supply system have less influence on the control of the power of the coil 5.

If the mains current or the phase shift is used as the actual value, the setpoint curve 13, 16 illustrated in FIGS. 5 and 6 may also have a positive control instead of the illustrated negative gradient. In specific cases, the gradient of the setpoint curve 13, 16 may even be zero.

If the power section 7 is configured as a frequency generator and the frequency of the induction current of the coil 5 is controlled by means of the control unit 9, the values of the setpoint curve 13, 16 are dependent on the period duration of the induction current, with the magnitude of the gradient of the setpoint curve preferably decreasing as the period duration of the induction current increases. The above-mentioned signals can also be used as actual values in the case of frequency control of the induction current.

It should be noted here that the curve profiles illustrated by way of example in FIGS. 3, 5 and 6 relate to an induction cooking appliance 1 with pulse control of the induction current. Curve profiles for an induction cooking appliance 1 with frequency control of the induction current, which curve profiles correspond to the curve profiles illustrated in FIGS. 3, 5 and 6, are also feasible. The curves for the power, the actual values and the setpoint curves are dependent on the period duration of the induction current in this case. The profiles of the curves can, in principle, be similar.

The setpoint curves 13, 16 are preferably also dependent on the type of cooking vessel, in particular on the size and/or on the type of structure of the cooking vessel 12. That is to say, different setpoint curves 13, 16 are preferably used for different cooking vessels 12 or types of cooking vessel. Therefore, the smaller the diameter of the cooking vessel 12, the greater the ratio of the induction current to the mains current, given the same type of structure for example. In the case of so-called multilayer cooking vessels, in particular multilayer pans, an induction current with a lower frequency should be used than in the case of cooking vessels, in particular in the case of pans, with a so-called sandwich-type base, since high heating powers can otherwise generally not be achieved. In addition, cooking vessels 12 comprising cast iron or other iron cooking vessels are distinguished by special properties which should be taken into account in the respective setpoint curve 13, 16.

If different setpoint curves 13, 16 are used depending on the type of cooking vessel, this leads to improved control and an improved adjustment or transient response of the power of the coil 5. A sample measurement relating to the cooking vessel 12 is preferably carried out in the method according to the invention. The setpoint curve 13, 16 of the induction current is selected as a function of the result of this sample measurement. In the case of pulse control of the induction current, the fixed fundamental or operating frequency is also preferably selected as a function of the result of the sample measurement. That is to say, the actual value determined during the sample measurement is used to draw a conclusion about the type of cooking vessel and a setpoint curve 13, 16 is selected from a range of setpoint curves as a function of the type of cooking vessel, it being possible for the range of setpoint curves to be stored in the control unit 9. Furthermore, the fixed fundamental or operating frequency of the induction current is preferably adjusted as a function of the type of cooking vessel.

If the coils 5 of adjacent hobs 2 are very close to one another, this may cause adjacent hobs 2 to influence each other. The quartz oscillators used in the power section 7 and from which the frequency of the induction current is derived typically have manufacturing tolerances, and this leads to minor frequency differences in the induction currents of adjacent hobs 2 or coils 5. This results in slow beats between adjacent hobs 2 or the coils 5 of said hobs, and this can lead to undesired power adjustments. Deliberate detuning of the frequencies of the induction currents of adjacent coils 5 (in the case of pulse control: of the operating or fundamental frequencies) leads to the beat being fast enough for its effect to be greatly reduced. For example, detuning by more than 100 hertz provides a considerable improvement. However, detuning of the respective frequency also leads to the maximum power which can be achieved by the coil 5 being influenced. The lower the frequency of the induction current, the higher the power. However, influencing the maximum power which can be achieved by a coil 5 is not necessarily desirable. Synchronous frequency switching between adjacent hobs 2 or coils 5 is preferably used to substantially eliminate the influence on the maximum power. In the process, adjacent coils 5 are operated with induction currents of different frequencies and the frequencies of the induction currents are switched at predetermined time intervals, for example every 100 milliseconds. In the case of pulse control, this relates to the operating or fundamental frequency. The switching times or the time until the next switching process can be stored in the control unit 9 like the frequencies at which the coils 5 are operated in each case. In an induction cooking appliance 1 with two adjacent hobs 2 and therefore two adjacent coils 5, the coil 5 of the first hob 2 is operated with an induction current with an operating or fundamental frequency of 22 kilohertz. The coil 5 of the second hob 2 is operated, for example, with an induction current with an operating or fundamental frequency of 22.2 kilohertz. After 100 milliseconds, the operating or fundamental frequencies are switched in such a way that the coil 5 of the first hob 2 operates at 22.2 kilohertz and the coil 5 of the second hob 2 operates at 22.0 kilohertz as the operating or fundamental frequency. The operating or fundamental frequencies of the induction currents of more than two coils 5 are accordingly switched.

The power density for the section of the base of a cooking vessel 12 typically decreases the further away it is from the center of the coil 5. This can lead to a visible difference in the cooking pattern, for example in the generation of bubbles in simmering water, and this is not necessarily desirable. This difference in the cooking pattern is less evident with oval coils 5, which are designed, in particular, as flat inductors, than with round coils 5. In the induction cooking appliance 1 according to the invention, at least one coil 5, preferably all the coils 5, is/are therefore advantageously of oval configuration. The oval shape of the coils 5 also results in a better utilization of space since the coil width is lower than with round coils 5, given a comparable power.

While preferred refinements and embodiments of the invention are described in the present application, reference is clearly made to the fact that the invention is not restricted to these and can also be implemented in other ways within the scope of the following claims.

1. A method for controlling an induction cooking appliance having at least one coil, wherein the power of the coil is adjusted as a function of a position of a cooking vessel on the coil.

2. The method as claimed in claim 1, wherein
an actual value, which is dependent on the position of the cooking vessel on the coil, is determined,
the actual value is compared with a predefined setpoint value so as to form a difference, and
when the actual value differs from the setpoint value, the power of the coil is adjusted in such a way that the actual value is adjusted to the setpoint value.

3. The method as claimed in claim 2, wherein the setpoint value is predefined as a value of a setpoint curve, the values of said setpoint curve being dependent on the pulse duration and/or the period duration of an induction current, with, in particular, the setpoint curve having a negative gradient.

4. The method as claimed in claim 3, wherein the magnitude of the gradient of the setpoint curve decreases as the pulse duration and/or period duration of the induction current increases.

5. The method as claimed in claim 2, wherein, when the actual value differs from the setpoint value, the power of the coil is adjusted by means of a controller, in particular a PID controller, with the difference forming an input variable for the controller.

6. The method as claimed in claim 2, wherein the power of the coil is adjusted by means of a change in the pulse duration and, or period duration of an induction current of the coil.

7. The method as claimed in claim 2, wherein the actual value is an induction current, a ratio between an induction current and a mains current, a phase shift of an induction current, a mains current, a ratio between a mains voltage and a mains current and/or a power which is output by the coil.

8. The method as claimed in claim 3, wherein the determined actual value is used to draw a conclusion about the type of cooking vessel and a setpoint curve is selected from amongst a range of setpoint curves as a function of the type of cooking vessel.

9. The method as claimed in claim 1, wherein, in the case of an induction cooking appliance with at least two adjacent coils, the adjacent coils are operated with induction currents of different frequencies, and the frequencies of the induction currents are switched at predefined time intervals.

10. An induction cooking appliance for heating a cooking vessel, which induction cooking appliance has at least one coil and a drive unit for the coil, wherein the induction cooking appliance, in particular the drive unit of said induction cooking appliance, is designed to execute a method according to one of the preceding claims.

11. The induction cooking appliance as claimed in claim 10, wherein at least one coil is of oval configuration.

12. The induction cooking appliance as claimed in claim 10, wherein at least one display unit is provided for displaying the momentary power of the at least one coil.
